(19) United States
(12) Patent Application Publication
(10) Pub. No.: US 2026/0290730 A1
(43) Pub. Date: Sep. 24, 2026

(54) Bellows for a Vacuum Interrupter

(71) Applicant: ABB Schweiz AG, Baden (CH)

(72) Inventor: Christian Reuber, Willich (DE)

(73) Assignee: ABB Schweiz AG, Baden (CH)

(21) Appl. No.: 19/576,279

(22) Filed: Mar. 24, 2026

(30) Foreign Application Priority Data
Mar. 24, 2025 (EP) 25165737.5

(51) Int. Cl. H01H 33/662

(52) U.S. Cl. CPC H01H 33/66238

(57) ABSTRACT

A bellows for a vacuum interrupter includes first and second collars connected by a flexible portion. An outer surface of the first collar includes two portions, the first portion having a projection and the second portion being adjacent to the first portion. The second collar couples to a first contact of the vacuum interrupter, and the first collar couples to an insulator that is connected to a second contact; when the first collar is coupled to the insulator, the outer surface faces towards an inner surface of the insulator and when the first collar is coupled to the insulator, the second portion of the outer surface does not contact the inner surface of the insulator.

### CROSS-REFERENCE TO RELATED APPLICATIONS

The instant application claims priority to European Patent Application No. 25165737.5, filed March 24, 2025, which is incorporated herein in its entirety by reference.

### FIELD OF THE DISCLOSURE

The present disclosure generally relates to vacuum interrupters.

### BACKGROUND OF THE INVENTION

In medium and high voltage vacuum interrupters, metal bellows are used to enable the motion of the movable contact. As these bellows are deep-drawn parts, their mechanical tolerances are relatively wide, e.g. compared to turned parts. This makes their manufacturing economic.

For a vacuum interrupter, the bellows are assembled with a cylindrical surface of the bellows aligned into a cylindrical surface of a neighboring part, which can for example be a turned part or a ceramic insulator. As the geometric tolerances of the diameters of bellows are relatively wide, and also the geometric tolerances of the neighboring part, for example ceramic insulators can also be relatively wide, a certain axial misalignment of the bellows with respect to a central axis of the vacuum interrupter is to be expected. This misalignment is acceptable in most general applications, for example for most circuit breakers. However, in some applications the axial misalignment can be problematic, and needs to be reduced to what is currently achievable.

A second issue arises when the bellows are directly brazed with a ceramic insulator. During the operational life of the vacuum interrupter, vaporization of the contact materials can occur. A metallic coating of the contact material then forms on the inside surface of the ceramic insulator. As the mechanical tolerances of the bellows, and possibly also of the ceramic insulator, are not great there can be a gap between the bellows and the ceramic insulator. The vaporized contact material forms to a certain extent a metallic coating on the surface of the ceramic insulator in the region under the collar of the bellows and certainly on the surface of the ceramic insulator right up to the collar of the bellows. Due to a possible axially misaligned assembly of bellows and ceramic insulator the bellows can touch the inner surface of the ceramic insulator and thus a galvanic contact is established between the bellows and the conductive metal layer, which can compromise the operation of the vacuum interrupter.

### BRIEF SUMMARY OF THE INVENTION

In an aspect, there is provIded a bellows for a vacuum interrupter, the bellows comprising: a collar; a second collar or mating portion; and a flexible portion. An outer surface of the collar comprises at least one first portion and at least one second portion. The at least one first portion comprises at least one projection that extends outwards from the outer surface of the collar. The at least one second portion is adjacent to the at least one first portion. The flexible portion is located between the collar and the second collar or mating portion. The second collar or mating portion is configured to couple to a first contact of the vacuum interrupter. The collar is configured to couple to an insulator of the vacuum interrupter. The insulator is connected to a second contact of the vacuum interrupter. When the collar is coupled to the insulator of the vacuum interrupter the outer surface of the collar faces towards an inner surface of the insulator of the vacuum interrupter. When the collar is coupled to the insulator of the vacuum interrupter the at least one second portion of the outer surface of the collar is configured not to contact the inner surface of the insulator of the vacuum interrupter.

Thus, the bellows can be spaced from an inner surface of the insulator where a conductive coating can be formed due to vaporisation of the material of the contacts of the vacuum interrupter. This vaporized conductive material forms a coating on the inner surface of the insulator over a part of the inner surface that extends under where the collar of the bellows is located. The vaporized conductive material also forms a coating on the inner surface of the insulator right up to the collar. Thus, without the projections, the collar can come into contact with the inner surface of the insulator where there is a conductive coating to make a galvanic connection. However, the at least one projection can be spaced from the end of the collar. Thus, there is still some conductive coating that extends under the collar, but does not reach where the projections are locating. Thus, the at least one projections do not contact the conductive coating and the other parts of the collar are spaced from the inner surfcae of the insulator and the conductive coating that is right up to the edge of the collar and that can alsio extend under the collar. Thus, a direct galvanic contact that could arise between the bellows cannot be made and the negative effects of such a galvanic contact is mitigated.

Furthermore, bellows are manufactured with wider tolerances than other parts of vacuum interrupters (not manufcatured so precisely), because misalignment of the bellows laterally with respect to the axis of the vacuum interrupters is generally not problematic, and the wider tolerances on the bellows proivdes for more economic manufacture of the bellows. However, in some cases, it is required that the bellows are more accurately centred around the axis of the vacuum interrupter. The new development enables the bellows to be better centred by providing the at least one projection that keeps the bellows centred without having to increase restrict tolerances of other parts of the bellows.

Thus, the new bellows can be used to replace an existing bellows of an existing vacuum interrupter to provide an overall system with a more accurately centred bellows and with a system that is mitigated.

### BRIEF DESCRIPTION OF THE SEVERAL VIEWS OF THE DRAWING(S)

FIG. 1 shows a representation of parts of a known vacuum interrupter in a closed position with a known bellows.

FIG. 2 shows a representation of parts of the known vacuum interrupter in an open position with the known bellows of FIG. 1.

FIG. 3 shows a representation of parts of the known vacuum interrupter in the open position with the known bellows of FIG. 1.

FIG. 4 is a section view through the known vacuum interrupter of FIG. 1, from which the old bellows have been removed, and to which has been fitted a new bellows in accordance with the disclosure.

FIG. 5 shows a representation of parts of a new vacuum interrupter with a new bellows in accordance with the disclosure.

### DETAILED DESCRIPTION OF THE INVENTION

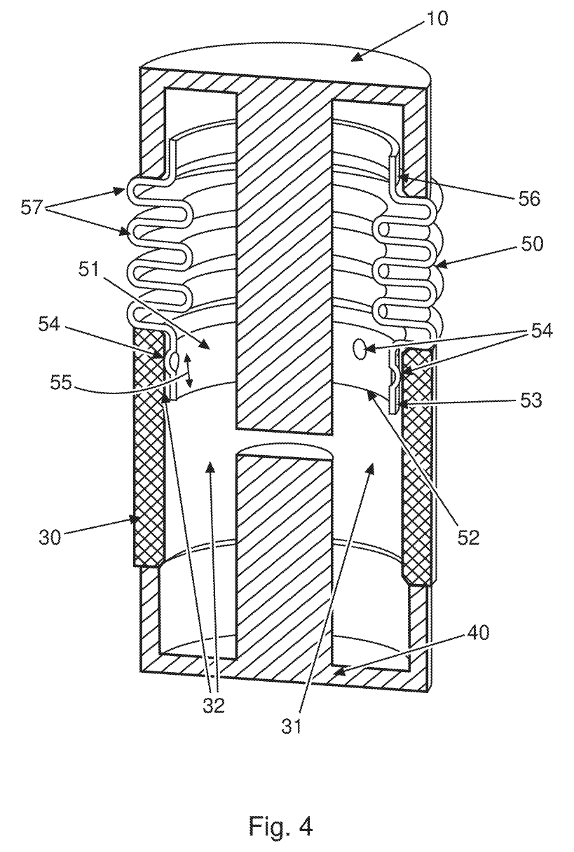

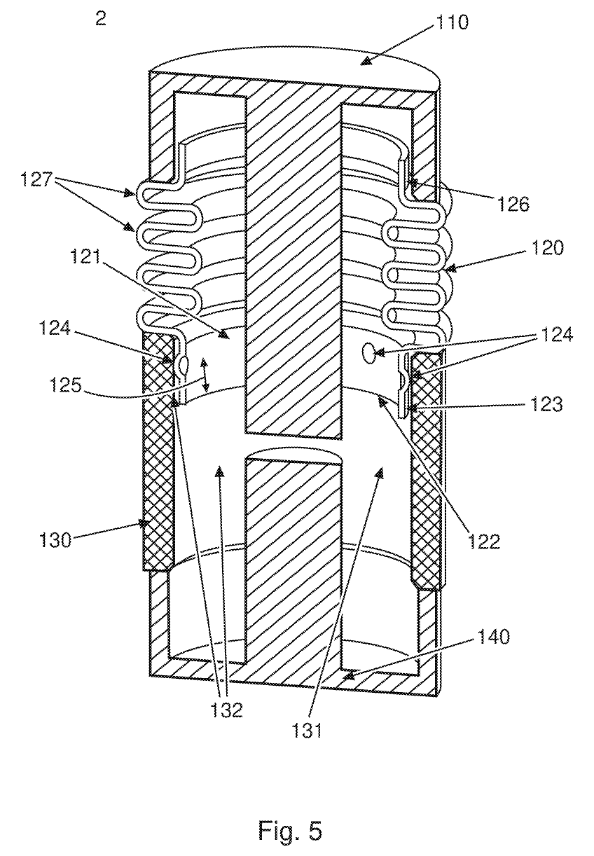

FIGS. 4-5 relate to a new bellows for a vacuum interrupter and to a vacuum interrupter with such new bellows. An exemplar bellows 50 for a vacuum interrupter 1 is now described. The bellows 50 comprises: a collar 51; a second collar or mating portion 56; and a flexible portion 57.

An outer surface 53 of the collar 51 comprises at least one first portion and at least one second portion. The at least one first portion comprises at least one projection 54 that extends outwards from the outer surface 53 of the collar 51. The at least one second portion is adjacent to the at least one first portion. The flexible portion 57 is located between the collar 51 and the second collar or mating portion 56. The second collar or mating portion 56 is configured to couple to a first contact 10 of the vacuum interrupter 1. The collar 51 is configured to couple to an insulator 30 of the vacuum interrupter 1. The insulator 30 is connected to a second contact 40 of the vacuum interrupter 1. When the collar 51 is coupled to the insulator 30 of the vacuum interrupter 1 the outer surface 53 of the collar 51 faces towards an inner surface 31 of the insulator 30 of the vacuum interrupter 1. When the collar 51 is coupled to the insulator 30 of the vacuum interrupter 1 the at least one second portion of the outer surface 53 of the collar 51 is configured not to contact the inner surface 31 of the insulator 30 of the vacuum interrupter 1.

This is shown for example in FIG. 4, where parts of the outer surface 53 of the collar 51 between projections 54 and the bottom edge 52 of the collar 51 are held away from the inner surface 31 of the insulator 30 and thus held away from any partly conductive coating 32 that can form on the inner surface 31 of the insulator 30. Thus, the bellows can be spaced from an inner surface of the insulator where a conductive coating can be formed due to vaporisation of the material of the contacts of the vacuum interrupter. This vaporized conductive material forms a coating on the inner surface of the insulator over a part of the inner surface that extends under where the collar of the bellows is located. The vaporized conductive material also forms a coating on the inner surface of the insulator right up to the collar. Thus, without the projections, the collar can come into contact with the inner surface of the insulator where there is a conductive coating to make a galvanic connection. However, the at least one projection can be spaced from the end of the collar. Thus, there is still some conductive coating that extends under the collar, but does not reach where the projections are locating. Thus, the at least one projections do not contact the conductive coating and the other parts of the collar are spaced from the inner surfcae of the insulator and the conductive coating that is right up to the edge of the collar and that can alsio extend under the collar. Thus, a direct galvanic contact that could arise between the bellows cannot be made and the negative effects of such a galvanic contact is mitigated.

Furthermore, bellows are manufactured with wider tolerances than other parts of vacuum interrupters (not manufcatured so precisely), because misalignment of the bellows laterally with respect to the axis of the vacuum interrupters is generally not problematic, and the wider tolerances on the bellows proivdes for more economic manufacture of the bellows. However, in some cases, it is required that the bellows are more accurately centred around the axis of the vacuum interrupter. The new development enables the bellows to be better centred by providing the at least one projection that keeps the bellows centred without having to restrict tolerances of other parts of the bellows. Thus, the new bellows can be used to replace an existing bellows of an existing vacuum interrupter to provide an overall system with a more accurately centred bellows and with a system that is mitigated.

It is thus to be noted that reference to “vacuum interupter“ means a vacuum interrupter without a bellows, where the new bellows is to be fitted to the “vacuum interrupter“. Thus, for example a vacuum interrupter has an old bellows removed, which is then replaced with the new bellows.

In an example, the at least one projection is formed by pressing the material of the collar of the bellows. In an example, the at least one projection is formed by proving material on the outer surface of the collar of the bellows. In an example, when the collar 51 is coupled to the insulator 30 of the vacuum interrupter 1 the at least one projection 54 that extends outwards from the outer surface 53 of the collar 51 is configured to contact the inner surface 31 of the insulator 30 of the vacuum interrupter 1. In an example, the at least one projection 54 comprises at least three projections 54. In an example, the at least three projections 54 comprise knobs 54. In an example, the at least three projections 54 comprise ridges 54. In an example, the at least one projection 54 comprises an annulus structure. In an example, the at least one projection 54 is spaced from an end 52 of the collar 51, and the end 52 of the collar 51 is at an opposite end of the collar to the flexible portion 57.

In an example, at least one centre of the at least one projection 54 is spaced from the end 52 of the collar 51 by a distance 55. In an example, the first contact 10 of the vacuum interrupter 1 is a moveable contact 10 and the second contact 40 of the vacuum interrupter is a fixed contact 40.

In an example, the second collar or mating portion is a second collar 56. An outer surface of the second collar 56 comprises at least one first portion and at least one second portion. The at least one first portion comprises at least one projection that extends outwards from the outer surface of the second collar 56. The at least one second portion is adjacent to the at least one first portion of the second collar 56. When the second collar 56 is coupled to the first contact 10 of the vacuum interrupter 1 the outer surface of the second collar 56 faces towards an inner surface of the first contact 10 of the vacuum interrupter 1. When the second collar 56 is coupled to the first contact 10 of the vacuum interrupter 1 the at least one second portion of the outer surface of the second collar 56 is configured not to contact the inner surface of the first contact 10 of the vacuum interrupter 1. Thus, the bellows along its length has its central axis more closely aligned with an overall central axis of the vacuum interrupter because both end collars of the bellows have been aligned with the overall central axis.

In an example, when the second collar 56 is coupled to the first contact 10 of the vacuum interrupter 1 the at least one projection that extends outwards from the outer surface of the second collar 56 is configured to contact the inner surface of the first contact 10 of the vacuum interrupter 1.

In an example, the at least one projection that extends outwards from the outer surface of the second collar 56 comprises at least three projections. In an example, the at least three projections that extend outwards from the outer surface of the second collar 56 comprise knobs. In an example, the at least three projections that extend outwards from the outer surface of the second collar 56 comprise ridges. In an example, the at least one projection that extends outwards from the outer surface of the second collar 56 comprises an annulus structure. The above described bellows can be retrofitted to parts of an existing vacuum interrupter.

However, a new vacuum interrupter can be manufcatured with the new bellows. Such an exemplar new vacuum interrupter 2 comprises: a first contact 110; a second contact 140; an insulator 130; and a bellows 120. The insulator 130 is connected to the second contact 140 of the vacuum interrupter 2. The bellows 120 comprises: a collar 121; a second collar or mating portion 126; and a flexible portion 127.

An outer surface 123 of the collar 121 comprises at least one first portion and at least one second portion. The at least one first portion comprises at least one projection 124 that extends outwards from the outer surface 123 of the collar 121. The at least one second portion is adjacent to the at least one first portion. The flexible portion 127 is located between the collar 121 and the second collar or mating portion 126. The second collar or mating portion 126 is to coupled to the first contact 110 of the vacuum interrupter 2. The collar 121 is coupled to the insulator 130. The outer surface 123 of the collar 121 faces towards an inner surface 131 of the insulator 130. The at least one second portion of the outer surface 123 of the collar 121 is configured not to contact the inner surface 131 of the insulator 130.

This is shown for example in FIG. 5, where parts of the outer surface 123 of the collar 121 between projections 124 and the bottom edge 122 of the collar 121 are held away from the inner surface 131 of the insulator 130 and thus held away from any partly conductive coating 132 that can form on the inner surface 131 of the insulator 130.

Thus, the bellows can be spaced from an inner surface of the insulator where a conductive coating can be formed due to vaporisation of the material of the contacts of the vacuum interrupter. This vaporized conductive material forms a coating on the inner surface of the insulator over a part of the inner surface that extends under where the collar of the bellows is located. Thus, without the projections, the collar can come into contact with the inner surface of the insulator where there is a conductive coating to make a galvanic connection. However, the at least one projection can be spaced from the end of the collar. Thus, there is still some conductive coating that extends under the collar, but does not reach where the projections are locating. Thus, the at least one projections do not contact the conductive coating and other parts of the collar are spaced from the coating. Thus, a direct galvanic contact that could arise between the bellows and an insulator is mitigated.

Furthermore, bellows are manufactured with wider tolerances than other parts of vacuum interrupters, because misalignment of the bellows laterally with respect to the axis of the vacuum interrupters is generally not problematic. However, in some cases, it is required that the bellows are more accurately centred around the axis of the vacuum interrupter. The new development enables the bellows to be better centred by providing the at least one projection that keeps the bellows centred without having to restrict tolerances of other parts of the bellows.

In an example, the at least one projection is formed by pressing the material of the collar of the bellows. In an example, the at least one projection is formed by proving material on the outer surface of the collar of the bellows.

In an example, the at least one projection 124 that extends outwards from the outer surface 123 of the collar 121 is configured to contact the inner surface 131 of the insulator 130. In an example, the at least one projection 124 comprises at least three projections 124. In an example, the at least three projections 124 comprise knobs 124. In an example, the at least three projections 124 comprise ridges 124. In an example, the at least one projection 124 comprises an annulus structure. In an example, the at least one projection 124 is spaced from an end 122 of the collar 121, and the end 122 of the collar 121 is at an opposite end of the collar to the flexible portion 127. In an example, a centre of the at least one projection 124 is spaced from the end 122 of the collar 121 by a distance 125. In an example, the first contact 110 is a moveable contact 110 and the second contact 140 is a fixed contact 140.

In an example, the second collar or mating portion is a second collar 126. An outer surface of the second collar 126 comprises at least one first portion and at least one second portion. The at least one first portion comprises at least one projection that extends outwards from the outer surface of the second collar 126. The at least one second portion is adjacent to the at least one first portion of the second collar 126. The outer surface of the second collar 126 faces towards an inner surface of the first contact 110 of the vacuum interrupter 2. The at least one second portion of the outer surface of the second collar 126 is configured not to contact the inner surface of the first 110 of the vacuum interrupter 2. Thus, the bellows along its length has its central axis more closely aligned with an overall central axis of the vacuum interrupter because both end collars of the bellows have been aligned with the overall central axis.

In an example, the at least one projection that extends outwards from the outer surface of the second collar 126 is configured to contact the inner surface of the first contact 110 of the vacuum interrupter 2. In an example, the at least one projection that extends outwards from the outer surface of the second collar 126 comprises at least three projections. In an example, the at least three projections that extend outwards from the outer surface of the second collar 126 comprise knobs. In an example, the at least three projections that extend outwards from the outer surface of the second collar 126 comprise ridges. In an example, the at least one projection that extends outwards from the outer surface of the second collar 126 comprises an annulus structure.

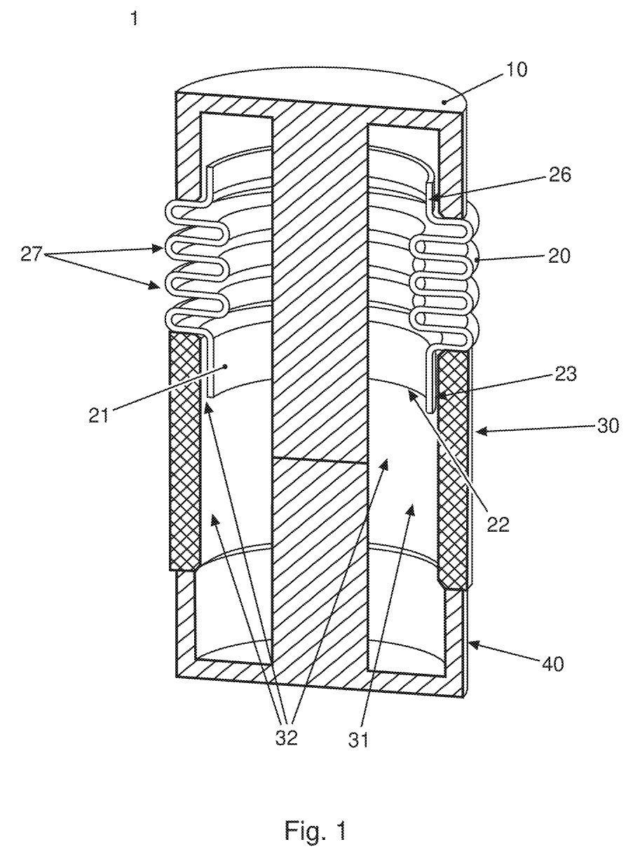

The new bellows for a vacuum interrupter and the vacuum interrupter with such new bellows is now described in detail with respect to a detailed embodiment and with respect to FIGS. 4-5. However, first the existing situation is described with respect to FIGS. 1-3.

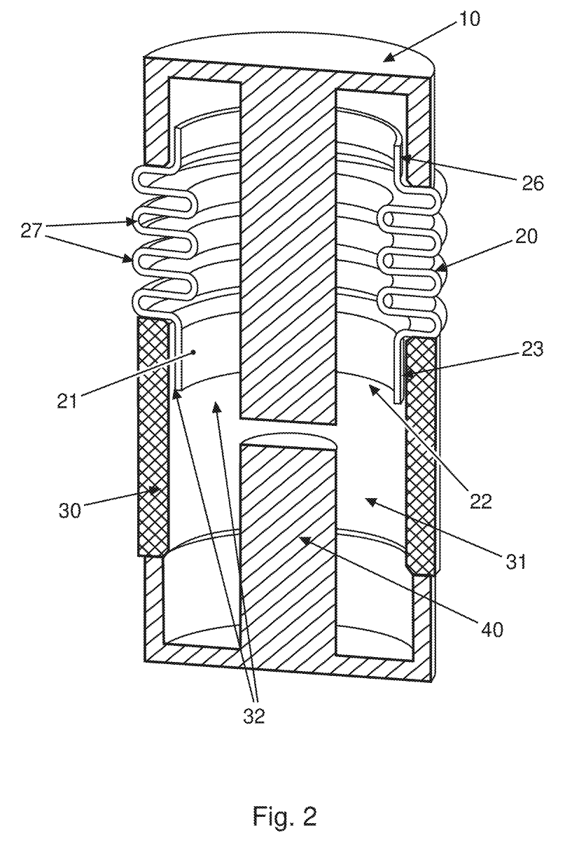

FIG. 1 shows parts of a known vacuum interrupter 1 with a known bellows in a closed position. FIG. 2 shows the vacuum interrupter in an open position. The collar 21 of the bellows 20 is aligned into the insulator 30 of the vacuum interrupter 1. After stacking all the components, the vacuum interrupter undergoes an evacuation and brazing process.

The interruption of a current in a vacuum interrupter is initiated by opening the contacts while an AC-current is flowing through the vacuum interrupter. The current will form an arc between the contacts. The arc will continue to burn until the next zero-crossing of the AC-current. Heat is generated on the contact surfaces and results in evaporated metal. This metal will partly condense also on the inner surface of the ceramic insulator, reducing the ability of the VI to electrically insulate. Generally, vacuum interrupters have inner shields to catch most of the evaporated metal, which is not shown here for clarity, but nevertheless every area of the inner surface of a vacuum interrupter can be reached by a fraction of said vaporous metal. After many operations, depending on design, application, magnitude of current and number of interruptions, a partly conductive layer can be formed on the inner surface of the ceramic insulator.

This is acceptable to a certain degree. However, when this partly conductive area has a direct electrical connection to one of the vacuum interrupter contacts, the insulating properties of the vacuum interrupter are impaired, as the effective insulating distance between the VI contacts is reduced.

Thus, continuing with FIGS. 1-3, due to vaporization of material of the moveable contact 10 and fixed contact 40 of the vacuum interrupter 1 a partly conductive coating 32 can form on the inner surface 31 of the insulator 30. The partly conductive coating 32 can form on the inner surface 31 of the insulator 30 right up to the bottom edge or end 52 of the collar 51 of the bellows 50. Indeed, the partly conductive coating 32 can form on the inner surface 31 of the insulator 30 that is slightly under the bottom edge or end 52 of the collar 51 of the bellows 50, because the bellows is made with wide tolerances and there is generally a gap between the collar 51 of the bellows and the insulator 30.

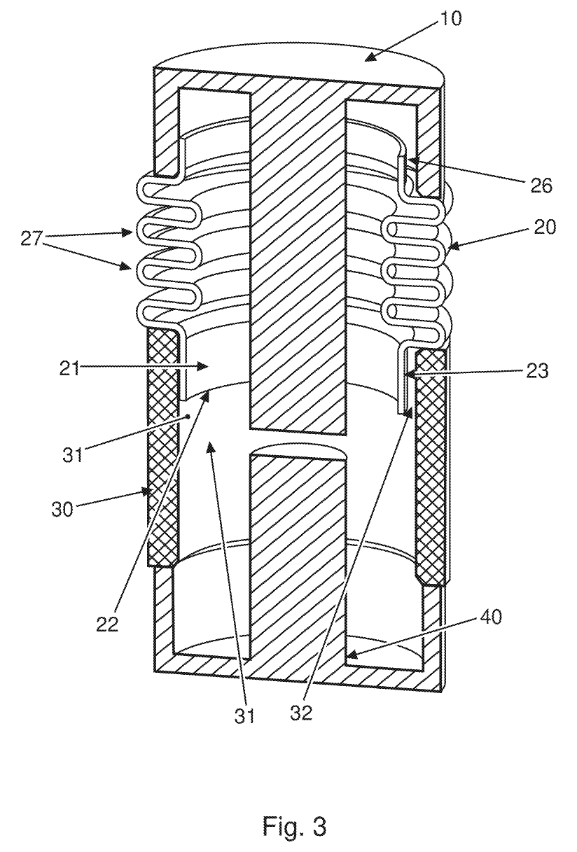

Due to the relatively large tolerances of the inner diameter of the ceramic insulator 30 and the outer diameter of the collar 21 of the bellows 20, a certain lateral displacement between the ceramic insulator 30 and the bellows 20 can occur. Indeed, as shown in FIG. 3 the collar 21 of the bellows 20 has touched the inner surface 31 of the ceramic insulator 30, and a galvanic contact has been made between the bellows 20 and a partly conductive coating 32 on the inner surface 31 of the insulator 30, and the insulation properties of the vacuum interrupter 1 have been negatively affected. The new bellows design came about to address this issue, and also a situation in which a vacuum interrupter with a bellows should be more accurately axially aligned with other components of the vacuum interrupter.

Thus, looking at FIG. 4 the collar 51 of the bellows 50 has three protrusions or projections 54 in outer surface 53 of the collar 51, where in FIG. 4 they are in effect knobs 54. These projections 54 could be formed by pressing the collar 51 from the inside with a press having a small circular form. However, a single projection 54 in the form of an annulus could be formed, or rather than having circular shaped knobs as a projection they could be more linear in form (sections of an annulus). The projections 54 are spaced from the end 52 of the collar 51 of the bellows 50 by a distance 55 that ensures that where the conductive coating 32, from contact evaporation, has formed on the inner surface 31 of the insulator 30 under the collar 51, the projections 54 do not contact it. Thus, an outer surface 53 of the collar that would previously have made a galvanic electrical connection to the conductive coating 32 on the inner surface 31 of the insulator 30 is now held spaced from the conductive coating 32. The insulation properties of the vacuum interrupter have thus not been compromised.

FIG. 4 shows the situation, where a new bellows 50 that has been retrofitted to parts of an existing vacuum interrupter 1. FIG. 5 shows a completely new vacuum interrupter 2 that has a new bellows 120 built into it. The bellows 120 can be the same as the bellows 50. Also, in FIGS. 4-5 the projections 54 are shown on only the lower collar 51, 121 of the bellows 50, 120. This mitigates against the above discussed issue of vacuum interrupter insulation degradation caused due to galvanic contact with the conductive coating 32, 132, and serves to help axially align the bellows 50, 120 more precisely. However, to further better axially align the bellows 50, 120, the second collar 56, 126, at the other end of the flexible portion 57, 127 of the bellows 50, 120 can also have projections from an outer surface. These projections of the second collar 56, 126 then engage with the inner surface of the moveable contact and serve to better axially align this end of the bellows 50, 120.

In the context of the present disclosure, reference to vacuum interrupter means a vacuum interrupter without a bellows, where the new bellows is to be fitted to the “vacuum interrupter“. Thus, for example a vacuum interrupter has an old bellows removed, which is then replaced with the new bellows.

In an example, the at least one projection is formed by pressing the material of the collar of the bellows. In an example, the at least one projection is formed by proving material on the outer surface of the collar of the bellows. In an example, when the collar is coupled to the insulator of the vacuum interrupter the at least one projection that extends outwards from the outer surface of the collar is configured to contact the inner surface of the insulator of the vacuum interrupter. In an example, the at least one projection comprises at least three projections. In an example, the at least three projections comprise knobs. In an example, the at least three projections comprise ridges. In an example, the at least one projection comprises an annulus structure. In an example, the at least one projection is spaced from an end of the collar, and the end of the collar is at an opposite end of the collar to the flexible portion. In an example, at least one centre of the at least one projection is spaced from the end of the collar by a distance. In an example, the first contact of the vacuum interrupter is a moveable contact and the second contact of the vacuum interrupter is a fixed contact.

In an example, the second collar or mating portion is a second collar. An outer surface of the second collar comprises at least one first portion and at least one second portion. The at least one first portion comprises at least one projection that extends outwards from the outer surface of the second collar. The at least one second portion is adjacent to the at least one first portion of the second collar. When the second collar is coupled to the first contact of the vacuum interrupter the outer surface of the second collar faces towards an inner surface of the first contact of the vacuum interrupter. When the second collar is coupled to the first contact of the vacuum interrupter the at least one second portion of the outer surface of the second collar is configured not to contact the inner surface of the first of the vacuum interrupter. Thus, the bellows along its length has its central axis more closely aligned with an overall central axis of the vacuum interrupter because both end collars of the bellows have been aligned with the overall central axis.

In an example, when the second collar is coupled to the first contact of the vacuum interrupter the at least one projection that extends outwards from the outer surface of the second collar is configured to contact the inner surface of the first contact of the vacuum interrupter. In an example, the at least one projection that extends outwards from the outer surface of the second collar comprises at least three projections.

In an example, the at least three projections that extend outwards from the outer surface of the second collar comprise knobs. In an example, the at least three projections that extend outwards from the outer surface of the second collar comprise ridges. In an example, the at least one projection that extends outwards from the outer surface of the second collar comprises an annulus structure.

The above described bellows can be retrofitted to parts of an existing vacuum interrupter. However, a new vacuum interrupter can be manufcatured with the new bellows.

Thus, in a second aspect, there is provided a vacuum interrupter, comprising: a first contact; a second contact; an insulator; and a bellows.

The insulator is connected to the second contact of the vacuum interrupter. The bellows comprises: a collar; a second collar or mating portion; and a flexible portion. An outer surface of the collar comprises at least one first portion and at least one second portion. The at least one first portion comprises at least one projection that extends outwards from the outer surface of the collar. The at least one second portion is adjacent to the at least one first portion. The flexible portion is located between the collar and the second collar or mating portion. The second collar or mating portion is to coupled to the first contact of the vacuum interrupter. The collar is coupled to the insulator. The outer surface of the collar faces towards an inner surface of the insulator. The at least one second portion of the outer surface of the collar is configured not to contact the inner surface of the insulator.

Thus, the bellows can be spaced from an inner surface of the insulator where a conductive coating can be formed due to vaporisation of the material of the contacts of the vacuum interrupter. This vaporized conductive material forms a coating on the inner surface of the insulator over a part of the inner surface that extends under where the collar of the bellows is located. Thus, without the projections, the collar can come into contact with the inner surface of the insulator where there is a conductive coating to make a galvanic connection. However, the at least one projection can be spaced from the end of the collar. Thus, there is still some conductive coating that extends under the collar, but does not reach where the projections are locating. Thus, the at least one projections do not contact the conductive coating and other parts of the collar are spaced from the coating. Thus, a direct galvanic contact that could arise between the bellows and an insulator is mitigated.

Furthermore, bellows are manufactured with wider tolerances than other parts of vacuum interrupters, because misalignment of the bellows laterally with respect to the axis of the vacuum interrupters is generally not problematic. However, in some cases, it is required that the bellows are more accurately centred around the axis of the vacuum interrupter. The new development enables the bellows to be better centred by providing the at least one projection that keeps the bellow centred without having to restrict tolerances of other parts of the bellows.

In an example, the at least one projection is formed by pressing the material of the collar of the bellows. In an example, the at least one projection is formed by proving material on the outer surface of the collar of the bellows. In an example, the at least one projection that extends outwards from the outer surface of the collar is configured to contact the inner surface of the insulator. In an example, the at least one projection comprises at least three projections. In an example, the at least three projections comprise knobs. In an example, the at least three projections comprise ridges. In an example, the at least one projection comprises an annulus structure. In an example, the at least one projection is spaced from an end of the collar, and the end of the collar is at an opposite end of the collar to the flexible portion.

In an example, a centre of the at least one projection is spaced from the end of the collar by a distance. In an example, the first contact is a moveable contact and the second contact is a fixed contact. In an example, the second collar or mating portion is a second collar. An outer surface of the second collar comprises at least one first portion and at least one second portion. The at least one first portion comprises at least one projection that extends outwards from the outer surface of the second collar. The at least one second portion is adjacent to the at least one first portion of the second collar. The outer surface of the second collar faces towards an inner surface of the first contact of the vacuum interrupter. The at least one second portion of the outer surface of the second collar is configured not to contact the inner surface of the first of the vacuum interrupter. Thus, the bellows along its length has its central axis more closely aligned with an overall central axis of the vacuum interrupter because both end collars of the bellows have been aligned with the overall central axis.

In an example, the at least one projection that extends outwards from the outer surface of the second collar is configured to contact the inner surface of the first contact of the vacuum interrupter. In an example, the at least one projection that extends outwards from the outer surface of the second collar comprises at least three projections. In an example, the at least three projections that extend outwards from the outer surface of the second collar comprise knobs. In an example, the at least three projections that extend outwards from the outer surface of the second collar comprise ridges. In an example, the at least one projection that extends outwards from the outer surface of the second collar comprises an annulus structure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE NUMERALS

10 Movable contact of a vacuum interrupter 1 (contact piece not shown) – state of the art

20 Bellows - state of the art

21 Collar of the bellows 20 – state of the art

22 End of the collar 21 of the bellows 20 - state of the art

23 Outer surface of the collar 21 of the bellows 20 - state of the art

26 Second collar of the bellows 20 – state of the art

27 flexible portion of the bellows 20 - state of the art

30 Insulator of the vacuum interrupter 1 - state of the art

31 Inner surface of the insulator 30 of the vacuum interrupter 1 - state of the art

32 Partly conductive coating on part of the inner surface 31 of the insulator 30

40 Fixed contact of the vacuum interrupter 1 (contact piece not shown) – state of the art

50 Bellows – new

51 Collar of the bellows 50 – new

52 End of the collar 51 of the bellows 50 – new

53 Outer surface of the collar 51 of the bellows 50 – new

54 At least one protrusion in the outer surface 53 of the collar 51 of the bellows 50 – new

55 A distance of the at least one protrusion 54 in the outer surface 53 of the collar 51 of the bellows 50 from the end 52 of the collar 51 of the bellows 50 – new

56 Second collar of the bellows 50 – new

57 flexible portion of the bellows 50 – new

110 Movable contact of a vacuum interrupter 2 (contact piece not shown) – new

120 Bellows of the vacuum interrupter 2 – new

121 Collar of the bellows 120 of the vacuum interrupter 2– new

122 End of the collar 121 of the bellows 120 of the vacuum interrupter 2 – new

123 Outer surface of the collar 121 of the bellows 120 of the vacuum interrupter 2 – new

124 At least one protrusion in the outer surface 123 of the collar 121 of the bellows 120 of the vacuum interrupter 2 – new

125 A distance of the at least one protrusion 124 in the outer surface 123 of the collar 121 of the bellows 120 of the vacuum interrupter 2 from the end 122 of the collar 121 of the bellows 120 of the vacuum interrupter 2 – new

126 Second collar of the bellows 120 of the vacuum interrupter 2 – new

127 flexible portion of the bellows 120 – new

130 Insulator of the vacuum interrupter 2 – new

131 Inner surface of the insulator 130 of the vacuum interrupter 2 – new

132 Partly conductive coating on part of the inner surface 131 of the insulator 130 of the vacuum interrupter 2 - new

140 Fixed contact of the vacuum interrupter 2 (contact piece not shown) – new

What is claimed is:

1. A bellows for a vacuum interrupter, the bellows comprising:
a collar;
a second collar or mating portion; and
a flexible portion;
wherein an outer surface of the collar comprises at least one first portion and at least one second portion, wherein the at least one first portion comprises at least one projection that extends outwards from the outer surface of the collar, and wherein the at least one second portion is adjacent to the at least one first portion;
wherein the flexible portion is located between the collar and the second collar or mating portion;
wherein the second collar or mating portion is configured to couple to a first contact of the vacuum interrupter;
wherein the collar is configured to couple to an insulator of the vacuum interrupter, wherein the insulator is connected to a second contact of the vacuum interrupter;
wherein when the collar is coupled to the insulator of the vacuum interrupter the outer surface of the collar faces towards an inner surface of the insulator of the vacuum interrupter; and
wherein when the collar is coupled to the insulator of the vacuum interrupter the at least one second portion of the outer surface of the collar is configured not to contact the inner surface of the insulator of the vacuum interrupter.

2. The bellows of claim 1, wherein, when the collar is coupled to the insulator of the vacuum interrupter, the at least one projection that extends outwards from the outer surface of the collar is configured to contact the inner surface of the insulator of the vacuum interrupter.

3. The bellows of claim 1, wherein the at least one projection comprises at least three projections.

4. The bellows of claim 3, wherein the at least three projections comprise knobs.

5. The bellows of claim 3, wherein the at least three projections comprise ridges.

6. The bellows of claim 1, wherein the at least one projection comprises an annulus structure.

7. The bellows of claim 1, wherein the at least one projection is spaced from an end of the collar, and wherein the end of the collar is at an opposite end of the collar to the flexible portion.

8. The bellows of claim 7, wherein at least one center of the at least one projection is spaced from an end of the collar by an offset distance.

9. The bellows of claim 1, wherein the first contact of the vacuum interrupter is a moveable contact and the second contact of the vacuum interrupter is a fixed contact.

10. The bellows of claim 1, wherein the second collar or mating portion is a second collar, wherein an outer surface of the second collar comprises at least one first portion and at least one second portion, wherein the at least one first portion comprises at least one projection that extends outwards from the outer surface of the second collar, wherein the at least one second portion is adjacent to the at least one first portion, wherein when the second collar is coupled to the first contact of the vacuum interrupter, the outer surface of the second collar faces towards an inner surface of the first contact of the vacuum interrupter.

11. The bellows of claim 10, wherein when the second collar is coupled to the first contact of the vacuum interrupter, the at least one second portion of the outer surface of the second collar is configured not to contact the inner surface of the first of the vacuum interrupter.

12. A vacuum interrupter, comprising:
a first contact;
a second contact;
an insulator; and
a bellows;
wherein the insulator is connected to the second contact of the vacuum interrupter;
wherein the bellows (120) comprises:
a collar;
a second collar or mating portion; and
a flexible portion;
wherein an outer surface of the collar comprises at least one first portion and at least one second portion, wherein the at least one first portion comprises at least one projection that extends outwards from the outer surface of the collar, and wherein the at least one second portion is adjacent to the at least one first portion;
wherein the flexible portion is located between the collar and the second collar or mating portion;
wherein the second collar or mating portion is coupled to the first contact of the vacuum interrupter;
wherein the collar is coupled to the insulator;
wherein the outer surface of the collar faces towards an inner surface of the insulator; and
wherein the at least one second portion of the outer surface of the collar is configured not to contact the inner surface of the insulator.

13. The vacuum interrupter of claim 12, wherein the at least one projection that extends outwards from the outer surface of the collar is configured to contact the inner surface of the insulator.

14. The vacuum interrupter of claim 12, wherein the at least one projection comprises at least three projections.

15. The vacuum interrupter of claim 14, wherein the at least three projections comprise knobs.

16. The vacuum interrupter of claim 12, wherein the at least one projection is spaced from an end of the collar, and wherein the end of the collar is at an opposite end of the collar to the flexible portion.
